(19) United States
(12) Patent Application Publication
(10) Pub. No.: US 2005/0185201 A1
(43) Pub. Date: Aug. 25, 2005

(54) Image processing apparatus and method of image processing

(76) Inventor: Naoki Kuwata, Nagano-ken (JP)

Correspondence Address: MARTINE PENILLA & GENCARELLA, LLP, 710 LAKEWAY DRIVE, SUITE 200, SUNNYVALE, CA, 94085, US

(21) Appl. No.: 10/980,606

(22) Filed: Nov. 2, 2004

(30) Foreign Application Priority Data
Nov. 5, 2003 (JP) 2003-375259
Jul. 7, 2004 (JP) 2004-199953

(51) Int. Cl. G06K 1/00; B41B 1/00; B41J 1/00; G06F 15/00

(52) U.S. Cl. 358/1.9

(57) ABSTRACT

A frame image data specifying module 22 specifies an arbitrary one piece of frame image data from among specified moving image data MD, and a continuous frame image data acquiring module 23 acquires a frame image data that is continuous with the specified frame image data. A major subject image data specifying module 25 uses the specified frame image data and the continuous frame image data to specify major subject image data from among the specified frame image data. An image quality characteristic acquiring module 25 scans the specified major subject image data to acquire image characteristic values that indicate characteristics of image quality of the major subject image data, and uses reference values and the acquired image quality characteristic values to determine correction values for the specified frame image data. An image quality adjusting module 26 applies the determined correction values to the specified frame image data.

### BACKGROUND OF THE INVENTION

1. Field of Technology

The present invention relates to a technology of image processing for image data (static image data) that was clipped out of plural pieces of image data continuous in time series.

2. Description of the Related Art

Moving image data obtained from shooting by a video camera or the like is composed of plural pieces of frame image data (or field image data) that are continuous in time series. Consecutive image data obtained from rapid shooting by a digital still camera or the like is also composed of plural pieces of image data that are continuous in time series and are independent of one another as separate image files. A known technique for clipping static image data out of plural pieces of image data, which constitute moving image data or consecutive image data as a whole and are continuous in time series one another, comprises a user designating a desired scene within the moving image data and using image data of the designated scene as static image data. In case where the moving image data is composed of plural pieces of image data, one piece of frame image data that corresponds to the designated scene may be used as the static image data.

Another known technique executes statistic processing for static image data to extract feature quantities regarding image quality of the static image data, and then uses the extracted feature quantities to apply image quality adjustment processing to the static image data. Such image processing technique allows for execution of image quality adjustment processing also for static image data that was clipped out of moving image data.

The conventional technique for clipping out frame image data (static image data), however, clips out one piece of static image data corresponding to a scene that was determined and clipped out by a user. This makes it extremely difficult to discriminate an important area in the image data i.e. an area in which a major subject exists and to execute image quality adjustment processing best suited to the area. For this reason, image quality adjustment processing has always been unsatisfactory for static image data that was clipped out of moving image data.

### SUMMARY OF THE INVENTION

The purpose of the present invention is to solve the above-mentioned problems and to execute image processing for static image data (image data) that was clipped out of plural pieces of image data continuous in time series, such as moving image data or consecutive image data, with emphasis on the improvement of image quality of a major subject.

In order to solve the above-mentioned problems, a first aspect of the present invention provides a method of image processing that executes image processing for image data, which was acquired from among plural pieces of image data that are continuous in time series. The method of image processing according to the third aspect of the present invention is characterized in comprising, acquiring continuous image data from among the plural pieces of image data that are continuous in time series, the continuous image data being data that is continuous with specific image data as, the specific image data being specified from among the plural pieces of image data that are continuous in time series; specifying major subject image data within the specific image data by using the specific image data and the continuous image data; acquiring image quality characteristics of the specific image data with emphasis on the specified major subject image data by analyzing the specific image data; and executing image quality adjustment for the specific image data by using the acquired image quality characteristics.

In accordance with the method of image processing according to the first aspect of the present invention, the specific image data is analyzed with emphasis on the specified major subject image data to acquire image quality characteristics of the specific image data, and the acquired image quality characteristics are then used to execute image quality adjustment for the specific image data. This allows for execution of image quality adjustment processing for static image data (image data), which was clipped out of plural pieces of image data that are continuous in time series such as moving image data or consecutive image data, with emphasis on the improvement of image quality of the major subject.

In the method of image processing according to the first aspect of the present invention, the acquiring image quality characteristics of the specific image data with emphasis on the specified major subject image data by analyzing the specific image data may be executed by raising the frequency of analysis for the specified major subject image data higher than that for the specific image data other than the specified major subject image data. In this way, the number of samplings acquired from the specified major subject image data may be larger than that acquired from the specific image data other than the specified major subject image data. This allows for acquisition of image quality characteristics of the specific image data with emphasis on image quality characteristics of the major subject image data.

In the method of image processing according to the first aspect of the present invention, the acquiring image quality characteristics of the specific image data with emphasis on the specified major subject image data by analyzing the specific image data may be executed by assigning larger weights to the image quality characteristics acquired from the specified major subject image data than to the image quality characteristics acquired from the specific image data other than the specified major subject image data. In this way, the weights assigned to the image quality characteristics acquired from the specified major subject image data may be larger than those assigned to the image quality characteristics acquired from the specific image data other than the specified major subject image data. This allows for acquisition of image quality characteristics of the specific image data with emphasis on image quality characteristics of the major subject image data.

In the method of image processing according to the first aspect of the present invention, the specifying major subject image data may be executed by specifying a minimal change area within the specific image data by using the specific image data and the continuous image data. In this way, the specific image data and the continuous image data are used to specify a minimal change area within the specific image data and thereby to specify major subject image data. That is to say, specification of specific image data allows for easy and proper specification of major subject image data. The term “minimal change area” used herein represents an area in which the magnitude of change remains zero or no more than a given value.

In the method of image processing according to the first aspect of the present invention, the image data may be composed of plural pieces of pixel data and the specifying a minimal change area may be executed by, from among the plural pieces of pixel data that constitute the image data, specifying an area in which variation between each constituent pixel data and its corresponding pixel data in the continuous image data is no more than the given value as a minimal change area. This allows for specification of a minimal change area on the basis of variation of each pixel data, which in turn allows for more accurate extraction of major subject image data.

In the method of image processing according to the first aspect of the present invention, the specifying major subject image data may include:
dividing the specific image data into a plurality of blocks; and
calculating a moving distance of each divided block in the continuous image data, and
the major subject image data may be specified with emphasis on a block with a moving distance of less than a given value among the plurality of block. This allows for specification of a minimal change area on the basis of the moving distances of the blocks, which in turn allows for more rapid extraction of major subject image data.

In the method of image processing according to the first aspect of the present invention, the executing image quality adjustment for the specific image data may be executed by increasing or decreasing preset correction values by using the acquired image quality characteristics. In this way, image quality adjustment can be executed for each specific image data by using the acquired correction values that reflect the image quality characteristics of the specific image data.

In the method of image processing according to the first aspect of the present invention, the image quality characteristics may be statistics of one or more image quality characteristic parameters that indicate characteristics of image quality of the specific image data, and the executing image quality adjustment for the specific image data may be executed by correcting the statistics so as to eliminate or reduce deviations between the acquired statistics of the one or more image quality parameters and reference parameter values preset for the one or more image quality parameters and then by using the corrected statistics. In this way, image quality adjustment can be executed for each specific image data according to the corrected statistics of the image quality characteristic parameters of the specific image data.

In the method of image processing according to the first aspect of the present invention, the image quality characteristics may be statistics of one or more image quality characteristic parameters that indicate characteristics of image quality of the specific image data, and the executing image quality adjustment for the specific image data may be executed by determining correction values so as to eliminate or reduce deviations between the acquired statistics of the one or more image quality parameters and reference parameter values preset for the one or more image quality parameters and then by applying the determined correction values to the specific image data. In this way, image quality adjustment can be executed appropriately for each specific image data by determining correction values according to the statistics of the image quality characteristic parameters of the specific image data and then by applying the determined correction values to the specific image data.

A second aspect of the present invention provides a method of image processing that executes image processing for image data, which was acquired from among plural pieces of image data that are continuous in time series. The method of image processing according to the second aspect of the present invention is characterized in comprising, acquiring a continuous scene from among the plural pieces of image data that are continuous in time series, the a continuous scene being another scene that is within a given time period from a specific scene, the specific scene being specified from among the plural pieces of image data that are continuous in time series; specifying a major subject area within the specific scene by using image data of the specific scene and image data of the continuous scene; acquiring image quality characteristics of the image data of the specific scene with emphasis on the specified major subject area by analyzing the image data of the specific scene; and executing image quality adjustment for the image data of the specific scene by using the acquired image quality characteristics.

In accordance with the method of image processing according to the second aspect of the present invention, the image data of the specific scene is analyzed with emphasis on the specified major subject area to acquire image quality characteristics thereof, and the acquired image quality characteristics are then used to execute image quality adjustment for the image data of the specific scene. This allows for execution of image quality adjustment processing for static image data (image data), which was clipped out of plural pieces of image data that are continuous in time series such as moving image data or consecutive image data, with emphasis on the improvement of image quality of the major subject.

The method of image processing according to the second aspect of the present invention may be realized as an image processing apparatus that executes image processing for image data, which was acquired from among plural pieces of image data that are continuous in time series.

In the method of image processing according to the second aspect of the present invention, the acquiring image quality characteristics of the image data of the specific scene with emphasis on the specified major subject area by analyzing the image data of the specific scene may be executed by raising the frequency of analysis for the image data of the specified major subject area higher than that for the image data of the specific scene other than the specified major subject area. In this way, the number of samplings acquired from the image data of the specified major subject area may be larger than that acquired from the image data of the specific scene other than the specified major subject area. This allows for acquisition of image quality characteristics of the image data of the specific scene with emphasis on image quality characteristics of the image data of the major subject area.

In the method of image processing according to the second aspect of the present invention, the acquiring image quality characteristics of the image data of the specific scene with emphasis on the specified major subject area by analyzing the image data of the specific scene may be executed by assigning larger weights to the image quality characteristics acquired from the image data of the specified major subject area than to the image quality characteristics acquired from the image data of the specific scene other than the specified major subject area. In this way, the weights assigned to the image quality characteristics acquired from the image data of the specified major subject image data may be larger than those assigned to the image quality characteristics acquired from the image data of the specific scene other than the image data of the specified major subject area. This allows for acquisition of image quality characteristics of the image data of the specific scene with emphasis on image quality characteristics of the image data of the major subject area.

In the method of image processing according to the second aspect of the present invention, the executing image quality adjustment for the image data of the specific scene may be executed by increasing or decreasing preset correction values by using the acquired image quality characteristics. In this way, image quality adjustment can be executed for the image data of each specific scene by using the acquired correction values that reflect the image quality characteristics of the image data of the specific scene.

A third aspect of the present invention provides an image processing apparatus that executes image processing for static image data, which was acquired from moving image data that is composed of plural pieces of image data. The image processing apparatus of the third aspect of the present invention is characterized in comprising: a continuous image data acquiring module that, from among the plural pieces of image data that are continuous in time series, acquires image data that is continuous with one piece of specific image data as continuous image data, the specific image data being specified from among the plural pieces of image data that are continuous in time series; a major subject image data specifying module that specifies major subject image data within the specific image data by using the specific image data and the continuous image data; an image quality characteristic acquiring module that acquires characteristics of image quality of the specific image data with emphasis on the specified major subject image data by analyzing the specific image data; and an image quality adjusting module that executes image quality adjustment for the specific image data by using the acquired image quality characteristics.

In accordance with the image processing apparatus according to the third aspect of the present invention, the similar functions and effects can be attained as those of the method of image processing according to the first aspect of the present invention. Additionally, the image processing apparatus according to the third aspect of the present invention may be realized in the similar various aspects as those of the method of image processing according to the first aspect of the present invention.

A fourth aspect of the present invention provides a method of generating image data that associates and outputs metadata with one piece of image data, which was selected from plural pieces of image data that are continuous in time series. The method of generating image data according to the fourth aspect of the present invention is characterized in comprising, acquiring continuous image data from among the plural pieces of image data that are continuous in time series, the continuous image data being image data that is continuous with one piece of specific image data, the specific image data being specified from among the plural pieces of image data that are continuous in time series; specifying a major subject area within the specific image data by using the specific image data and the continuous image data, the major subject area representing a major subject; and associating and outputting metadata with the specified specific image data, the metadata containing information regarding the specified major subject area or information generated by using the information regarding the specified major subject area.

According to the method of generating image data according to the fifth aspect of the present invention, metadata, which contains information regarding the specified major subject area and information generated by using the information regarding the specified major subject area, can be associated and output with the specified specific image data. This allows for execution of image quality adjustment processing in an image quality correcting apparatus for static image data (image data), which was clipped out of plural pieces of image data that are continuous in time series such as moving image data or consecutive image data, with emphasis on the improvement of image quality of major subject. The method of generating image data according to the fourth aspect of the present invention may be realized in the similar various aspects and may attain the similar functions and effects as those of the method of image processing according to the first aspect of the present invention.

A fifth aspect of the present invention provides a method of correcting image quality that executes image quality adjustment processing for image data by using metadata associated with the image data. The method of correcting image quality according to the fifth aspect of the present invention is characterized in comprising acquiring one piece of specific image data as metadata, the specific image data being specified from among plural pieces of image data that are continuous image data, metadata being associated with the specific image data and containing information regarding a major subject area specified within the specific image data and information generated by using the information regarding the specified major subject area; and executing image quality adjustment processing for the acquired specific image data by using the acquired metadata.

According to the method of correcting image quality according to the fifth aspect of the present invention, the acquired metadata is used for execution of image quality adjustment processing for the acquired specific image data. This allows for execution of image quality adjustment processing for static image data (image data), which was clipped out of plural pieces of image data that are continuous in time series such as moving image data or consecutive image data, with emphasis on the improvement of image quality of major subject. The method of correcting image data according to the fifth aspect of the present invention may be realized in the similar various aspects and may attain the similar functions and effects as those of the method of image processing according to the first aspect of the present invention.

The methods according to the first, second, fourth, and fifth aspects of the present invention may also be realized as programs or computer-readable recording media that are recorded with the programs. The methods according to the first, second, fourth, and fifth aspects of the present invention may also be realized as an image data processing apparatus, an image data generating apparatus, and an image data correcting apparatus, respectively.

In the first through fifth aspects of the present invention, the plural pieces of image data that are continuous in time series may also comprise moving image data.

### BRIEF DESCRIPTION OF THE DRAWINGS

FIG. 1 is an illustration showing the general arrangement of an image processing system that includes an image processing apparatus according to a first embodiment;

FIG. 2 shows a functional block diagram of a personal computer 20 (CPU 200) according to the first embodiment;

FIG. 3 is a flowchart showing a processing routine of image processing that is executed in the personal computer 20 according to the first embodiment;

FIG. 4 is a flowchart showing a processing routine that is executed to specify major subject image data;

FIG. 5 is a schematic diagram showing frame image data that is divided into plural blocks;

FIG. 6 is a schematic diagram showing frame image data that corresponds to a specified frame (I);

FIG. 7 is an illustration showing frame image data that corresponds to a frame (I+1) that is subsequent to the specified frame (I), as well as a block that shifts its position;

FIG. 8 is an illustration showing a concrete example of frame image data that corresponds to the frame (I);

FIG. 9 is an illustration showing a concrete example of frame image data that corresponds to the frame (I+1);

FIG. 10 is a schematic diagram showing major subject image data (area) acquired from the frame (I) shown in FIG. 8 and the frame (I+1) shown in FIG. 9;

FIG. 11 is an illustration showing another concrete example of frame image data that corresponds to the frame (I);

FIG. 12 is an illustration showing another concrete example of frame image data that corresponds to the frame (I+1);

FIG. 13 is a schematic diagram showing major subject image data (area) acquired from the frame (I) shown in FIG. 11 and the frame (I+1) shown in FIG. 12;

FIG. 14 is a functional block diagram showing the functional arrangement of an image data generating apparatus according to the second embodiment;

FIG. 15 is an illustration showing one example of major subject area within clipping frame image data and weighting factors assigned to its respective blocks;

FIG. 16 is an illustration showing one example of metadata that is associated with the clipping frame image data by means of the image data generating apparatus according to the second embodiment; and

FIG. 17 is a functional block diagram showing the functional arrangement of an image quality correcting apparatus according to the second embodiment.

### DETAILED DESCRIPTION OF THE PREFERRED EMBODIMENTS

The following describes an image processing apparatus and a method of image processing according to the present invention, based on embodiments and with reference to drawings. It should be noted herein that the image processing apparatus may also be realized as an image data generating apparatus or as an image quality correcting apparatus, as will be described in a second embodiment.

### First Embodiment

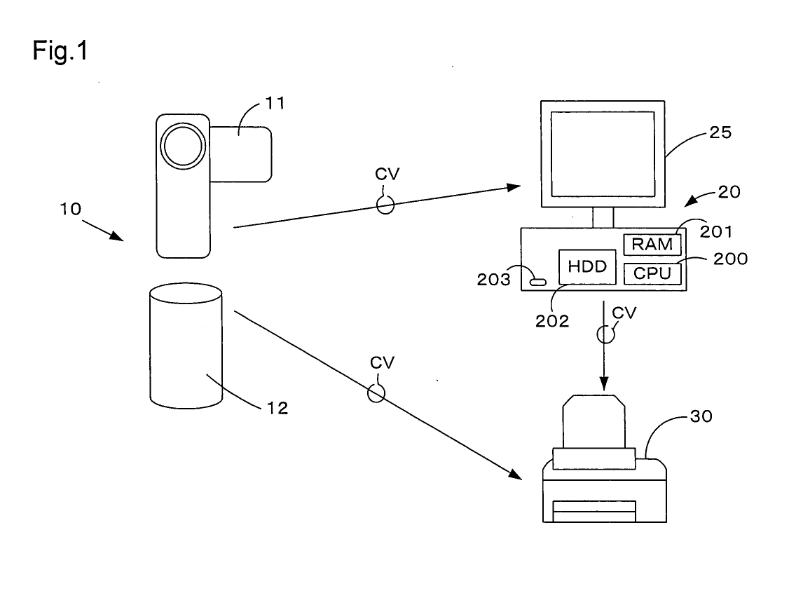

With reference to FIG. 1, the following describes an image processing system that includes an image processing apparatus according to a first embodiment. FIG. 1 is an illustration showing the general arrangement of an image processing system that includes an image processing apparatus according to a first embodiment.

The image processing system comprises: a moving image data resource 10 that includes a digital video camera 11 (including a digital still camera that is capable of shooting of moving images) as an input device for generating moving image data and a server 12 on a network for storing the moving image data; a personal computer 20 as an image processing apparatus for executing image quality adjustment processing for frame image data (static image data), which was clipped out of the moving image data obtained from the dynamic data resource 10; and a color printer 30 as an output device for outputting an image by using the frame image data that has undergone the image quality adjustment processing. Alternatively, the color printer 30 may be equipped with functions of image processing or functions that are achieved by the personal computer 20 in the above-mentioned arrangement. In such a case, the color printer 30 can execute both the image processing and the image output in a stand-alone mode. As for the output device, devices other than the printer 30 may alternatively be used as well, such as a monitor 25 (e.g. CRT display or LCD display) and a projector, for example. In the following description, however, the color printer 30 that is connected to the personal computer 20 will be used as the output device.

The personal computer 20 is a generally-used type of computer that includes: a central processing unit (CPU) 200 that executes various processing operations including an operation for clipping frame image data (static image data) out of moving image data, an operation for analyzing image quality characteristics of the clipped out frame image data with emphasis on major subject image data, and an operation for image processing on the basis of analysis results: a random access memory (RAM) 201 that temporally stores various data including the input moving image data, the clipped out frame image data, and the operation results; and a hard disc drive (HDD) 202 (or read only memory (ROM)) that stores various control programs including a program for executing various image processing for the frame image data that was clipped out of the moving image data. The personal computer 20 may also include an input/output terminal 203 (e.g. digital terminal or analog terminal) for receiving a connecting cable from the digital video camera 11 or the like, and may further include a memory card slot for receiving a memory card.

In the present embodiment, the personal computer 20 further stores decorative image data, which decorates major subject image data that was clipped out of the moving image data so as to generate static image data, and layout control information in the HDD 202. The decorative image data may be, for example, data of frame image or data of album cardboard on which plural pieces of major subject image data are pasted on, and may take the form of either bitmap data or vector data. The layout control information is in relation to the decorative image data and defines location and dimension of layout of the major subject image data with respect to the decorative image data, and is described in a script language that defines the location and dimension of layout of the major subject image data with respect to the decorative image data.

The digital video camera 11 is a camera that acquires a moving image by focusing optical information onto a digital device (photoelectric converter such as CCD or photomultiplier) and includes: a photoelectric converting circuit that includes CCD or the like for converting the optical information into electrical information; an image generating circuit for generating digital moving image data by controlling the photoelectric converting circuit; and an image processing circuit for processing the generated digital moving image data. The digital video camera 11 uses a recording medium such as magnetic tape, optical recording medium, or the like as a storage device to store the acquired digital moving image data. The digital video camera 11 generally employs DV format, which is composed of 30 pieces of image data (static image data) per second, as the data format of moving image data in the digital video camera 11. Another known format is MPEG2 format that attains high compressibility by storing reference image data and movement vectors (differential information) with respect to the reference image data. It goes without saying that any other various data format may alternatively be used as well, such as AVI or MPEG1, for example. In the present embodiment, the so-called “moving image data MD” represents any one of: moving image data that is composed of plural pieces of frame image data arranged in time series; moving image data that is composed of reference image data and differential information with respect to the reference image data; and moving image data of which a specific scene can be clipped out by time information. In other words, the so-called “moving image data MD that is composed of plural pieces of frame image data” may represent moving image data of which static image data of a specific scene (time) can be clipped out as well as moving image data that is composed of plural pieces of frame image data arranged in time series.

The server 12 stores moving image data uploaded by a user and moving image data provided by a content provider in its hard disk drive. The server 12 distributes its moving image data via the network at the request of the personal computer 20 or an apparatus for generating static image data.

The moving image data generated by the digital video camera 11 is forwarded to the personal computer 20 via e.g. a cable CV or a memory card. The static mage data generated in the personal computer 20 is transmitted to the color printer 30 via a cable CV. In case where the printer 30 is equipped with functions of generating static image data, the moving image data may alternatively be forwarded to the color printer 30 by attaching a memory card MC, in which the moving image data is stored by the digital video camera 11, to the printer 30. The following describes a case where the personal computer 20 executes image processing for image data and outputs the processed image data to the color printer 30.

The color printer 30 is a printer that is capable of outputting color images. For example, the color printer 30 is an inkjet printer that forms images by spouting four colors of inks, i.e. cyan (C), magenta (M), yellow (Y), and black (K) onto printing media to form dot patterns. The color printer 30 may alternatively be an electro-photographic printer that forms images by transferring and fixing color toners onto printing media. As for the color inks, light cyan (LC), light magenta (LM), red, and blue may also be used in addition to the four colors mentioned above.

### Image Processing in Personal Computer 20

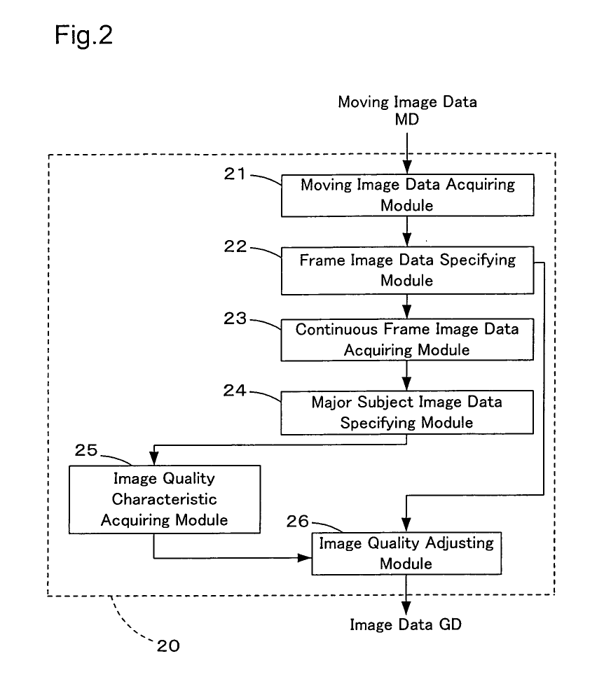

The following description provides a brief overview of the functional arrangement of the personal computer 20 (CPU 200) with reference to FIG. 2. FIG. 2 shows a functional block diagram of the personal computer 20 (CPU 200) according to the first embodiment. In the following description, moving image data is employed as an example of plural pieces of image data that are continuous in time series. Other examples of the plural pieces of image data that are continuous in time series may include consecutive image data that may be acquired from continuous shooting.

A moving image data acquiring module 21 in the personal computer 20 acquires moving image data MD that is composed of plural pieces of frame image data. A frame image data specifying module 22 in the personal computer 20 specifies one arbitrary scene (one piece of frame image data) within the acquired moving image data MD. A continuous frame image data acquiring module 23 in the personal computer 20 acquires frame image data that is continuous with the specified frame image data, such as frame image data that is immediately before or after the specified frame image data, for example.

A major subject image data specifying module 24 in the personal computer 20 specifies major subject image data that corresponds to a main subject within the specified frame image data by using the specified frame image data (specific image data) and the acquired continuous frame image data (continuous image data). An image quality characteristic acquiring module 25 in the personal computer 20 scans the specified major subject image data on a pixel-by-pixel basis to acquire image quality characteristic values (image statistics) that indicate characteristics of image quality of the major subject image data and then uses previously provided reference values and the acquired image quality characteristic values to determine correction values for the specified frame image data. An image quality adjusting module 26 in the personal computer 20 applies the correction values determined for the frame image data specified by the frame image data specifying module 22 to adjust the image quality thereof and then outputs image data GD for output-use.

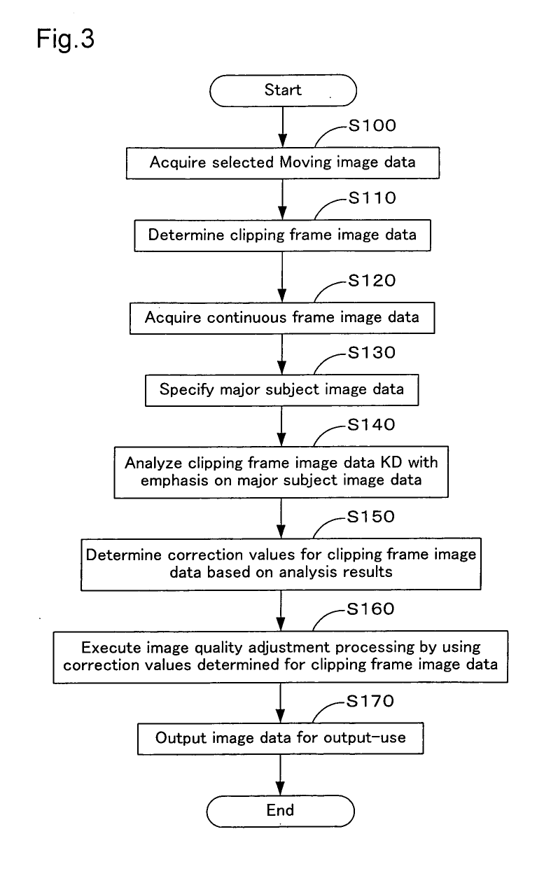

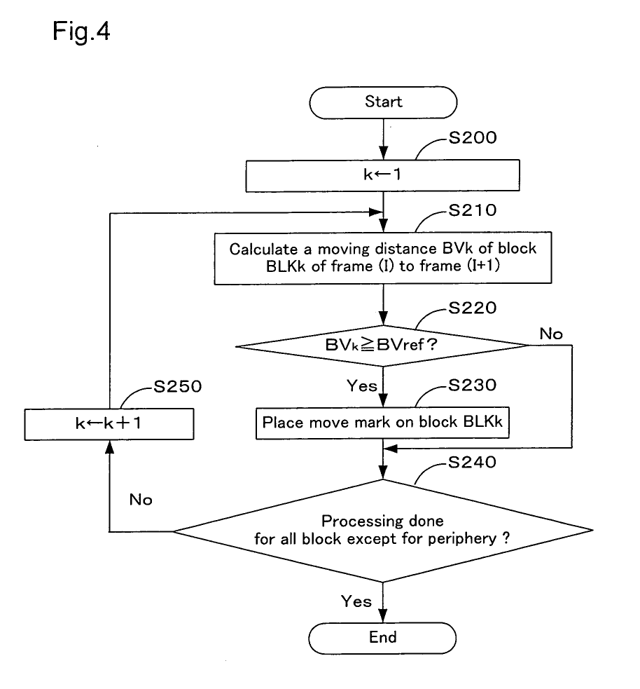

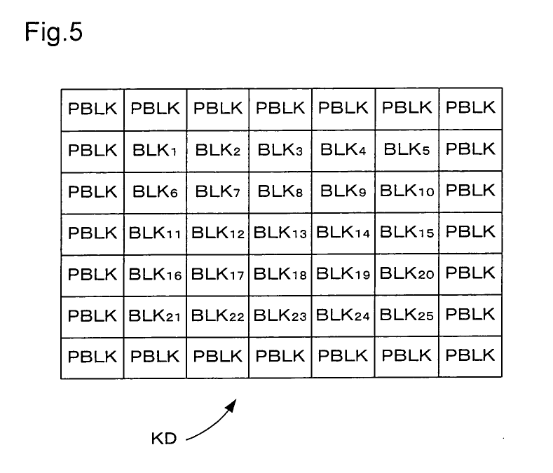

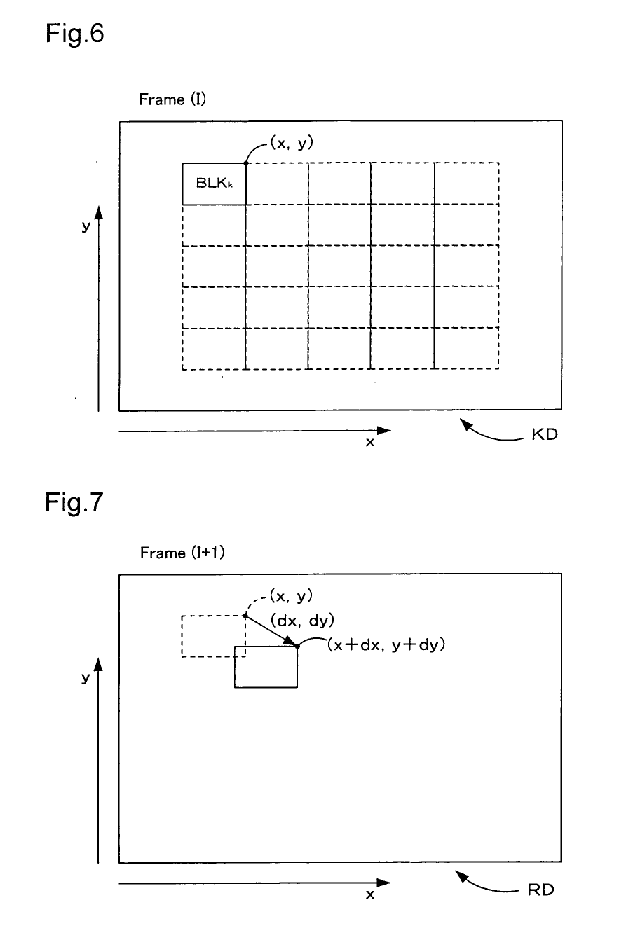

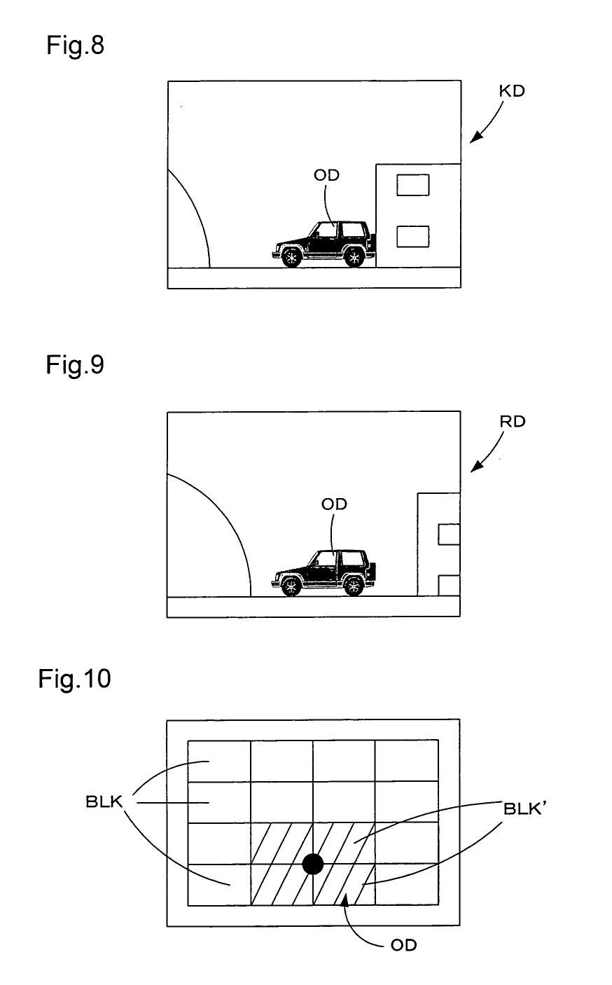

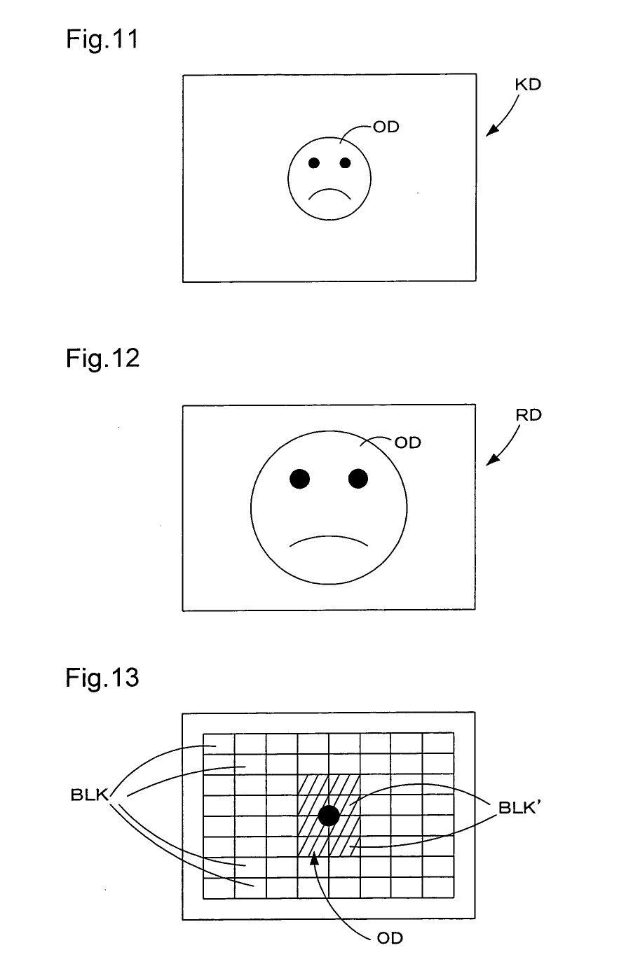

With reference to FIGS. 3 through 13, the following describes image processing that is executed in the personal computer 20 according to the first embodiment. FIG. 3 is a flowchart showing a processing routine of image processing that is executed in the personal computer 20 according to the first embodiment. FIG. 4 is a flowchart showing a processing routine that is executed to specify major subject image data. FIG. 5 is a schematic diagram showing frame image data that is divided into plural blocks. FIG. 6 is a schematic diagram showing frame image data that corresponds to a specified frame (I). FIG. 7 is an illustration showing frame image data that corresponds to a frame (I+1) that is subsequent to the specified frame (I), as well as a block that shifts its position. FIG. 8 is an illustration showing a concrete example of frame image data that corresponds to the frame (I). FIG. 9 is an illustration showing a concrete example of frame image data that corresponds to the frame (I+1). FIG. 10 is a schematic diagram showing major subject image data (area) acquired from the frame (I) shown in FIG. 8 and the frame (I+1) shown in FIG. 9. FIG. 11 is an illustration showing another concrete example of frame image data that corresponds to the frame (I). FIG. 12 is an illustration showing another concrete example of frame image data that corresponds to the frame (I+1). FIG. 13 is a schematic diagram showing major subject image data (area) acquired from the frame (I) shown in FIG. 11 and the frame (I+1) shown in FIG. 12.

Image processing of the present embodiment may be started when a memory card is attached to the personal computer 20 or when the digital video camera 11 is connected to the personal computer 20 via a communication cable, or may be executed when execution of image processing is directed by a user via a keyboard or the like.

When the image processing is started, the personal computer 20 (CPU 200) acquires moving image data MD that was selected by a user and temporally stores the data in the RAM 201. The moving image data MD, for example, may be selected in the personal computer 20 by the user manipulating a keyboard or the like. At this time, one or more pieces of moving image data MD may be selected. Alternatively, the moving image data MD may randomly be selected by the CPU 200 from among plural pieces of moving image data MD stored in the HDD 202 of the personal computer 20 or from among plural pieces of moving image data MD stored in the server 12 on the network.

The CPU specifies clipping frame image data KD (specific image data) out of the acquired moving image data MD (step S110). The frame image data to be clipped out may generally be designated by the user manipulating an input device such as keyboard or mouse, and the CPU 200 may specify clipping frame image data KD by a number and a time of the frame in response to the input designate information. Specifically, the user plays the moving image data MD on a monitor 25 and uses functions of advance-frame, back-frame, freeze-frame, and the like to designate a clipping location (frame location, frame number, and frame time) that is desired to be made into static image data, that is, clipping frame image data KD. In the present embodiment, the so-called “frame image data” represents plural pieces of static image data that constitute the moving image data MD as well as static image data that is dynamically generated through the use of reference image data, differential information, and time information.

In case where the moving image data MD employs DV format that is composed of plural pieces of frame image data (static image data), designation of frame image data by the user may directly results in specification of clipping frame image data KD. On the other hand, in case where the moving image data MD employs MPEG2 format that is composed of an intra frame (I picture) and P picture and B picture only having differential information with respect to the I picture, frame image data designated by the user does not exist in the form of frame image data within the moving image data MD. In such a case, the CPU 200 generates clipping frame image data KD from the intra frame (I picture) by using the differential information corresponding to the frame image data designated by the user and on the basis of time information.

Once the clipping frame image data KD is specified, the CPU 200 acquires continuous frame image data RD (continuous image data) that is continuous with the clipping frame image data KD (step S120). In case where the clipping frame image data KD has a frame number of I, the continuous frame image data RD may be acquired from frame image data that corresponds to a frame number immediately before or after I, that is, (I−1) or (I+1). In the present embodiment, the CPU 200 acquires frame image data that corresponds to a frame number immediately after I as the continuous frame image data RD.

The CPU 200 specifies major subject image data OD, which corresponds to an image of subject mainly focused at the time of shooting within the clipping frame image, by using the clipping frame image data KD and the continuous frame image data RD (step S130). In this processing for specifying, movement vectors are used in comparison with the continuous frame image data RD to specify an area with small movement (pixel data or block pixel data) within the clipping frame image data KD, and the area thus specified is used as the major subject image data.

With reference to FIG. 4, the following describes the processing for specifying major subject image data OD. As shown in FIG. 5, the CPU 200 divides the clipping frame image data KD (frame (I)) into a plurality of blocks BLKₖ, each of which being composed of m-by-n pieces of pixel data. The clipping frame image data KD may be divided into the same number of blocks in vertical and horizontal directions (on the order of 8-by-8 to 16-by-16, for example) such that the frame and the block may have the same horizontal to vertical ratio, or may alternatively be divided into different numbers of blocks in the vertical and horizontal directions. The larger the number of divided blocks is, the higher the accuracy in specifying the major subject image data becomes. In particular, for a zoom wide scene (frame) in which a major subject hardly moves, a large number of divided blocks may be desirable.

The CPU 200 initializes a block number (k) (step S200) and calculates a moving distance BVₖ of a block BLKₖ in the clipping frame image data KD (frame (I)) shown in FIG. 6 with respect to the continuous frame image data RD (frame (I+1)) shown in FIG. 7 (step S210).

The following describes one example of method of calculating the moving distance BVₖ. When a coordinate point (x, y) of the frame (I) has a pixel value of P0 (x, y); a coordinate point (x, y) of the frame (I+1) has a pixel value of P1 (x, y); a moving distance of the block BLK in the frame (I+1) is (dx, dy); a coordinate point after movement (x+dx, y+dy) of the block BLK in the frame (1+1) has a pixel value of P1 (x+dx, y+dy); and a movement threshold value BVref and the longer of vertical and horizontal dimensions of the clipping frame image data Cmax have the relationship of BVref=Cmax/20, where the coordinate point (x, y) represents a coordinate point within the entire frame image data, the CPU 200 calculates a differential pixel value DIF (dx, dy) between the pixel value of P0 (x, y) and the pixel value of P1 (x+dx, y+dy) by using the following equation (1):
DIF (dx, dy)=Σ abs (P0 (x, y)−P1 (x+dx, y+dy)) Equation (1),
where the symbol Σ represents the summation for every coordinate point (x, y) in the BLKₖ.

Specifically, the CPU 200 assigns values of −BVref<dx, dy<BVref to the variables dx, dy of the Equation (1), one by one in sequence, to acquire a minimum moving distance (dx min, dy min) that gives a minimum DIF (dx, dy). Accordingly, the coordinate point in the frame (I+1) that corresponds to the destination of the coordinate point (x, y) of the block BLKₖ in the frame (I) is (x+dx min, y+dy min).

The CPU 200 calculates the moving distance BVₖ of the block BLK by using the following equation (2):
BVₖ=(dx min²+dy min²)^{1/2} Equation (2).

The CPU 200 determines whether or not the moving distance BVₖ calculated for the block BLKₖ is no less than the threshold value BVref (step S220). Specifically, the CPU 200 determines whether or not the moving distance BVₖ of the target block BLKₖ is within the range that can be regarded as no movement. More specifically, the CPU 200 determines whether or not the moving distance of the block BLKₖ is zero or minimal variation (minimal change).

If it is determined that BVₖ≧BVref (YES returned in step S220), the CPU 200 puts a move mark on the block BLKₖ (step S230) and proceeds to step S240. On the other hand, if it is not determined that BVₖ>BV_{ref} (NO returned in step S220), the CPU 200 proceeds to step S240 without putting a move mark on the block BLKₖ.

The CPU 200 determines whether or not the processing of determining the moving distance BV is done for all blocks except for peripheral blocks PBLK (step S240), and if it is determined that the processing is done (YES returned in step S240), the CPU 200 ends the processing routine and returns to the processing of the flowchart shown in FIG. 3. The reason the peripheral blocks PBLK are excluded is that the major subject is generally shot at or near the center of the image data and that the image data at periphery may likely to disappear in the frame image data before or after the target frame image data as the major subject moves.

If it is determined that the processing of determining the moving distance BV is not yet done for all blocks except for the peripheral blocks PBLK (NO returned in step S240), the CPU 200 updates the number k of the block BLKₖ (step S250) and repeats the processing of steps S210 through S240 for the next block BLKₖ₊₁.

Returning to FIG. 3, the CPU 200 analyzes the clipping frame image data KD with emphasis on the specified major subject image data OD (step S150). As described previously, among the respective blocks BLKₖ of the clipping frame image data KD (frame (I)), any block BLKₖ that is determined to have movement in the continuous frame image data RD (frame (I+1)) has a move mark set thereon. It is therefore the blocks BLKₖ with no move mark that correspond to the area with slow movement in the clipping frame image data KD (frame (I)), that is, the major subject image data OD. In this way, the analysis of image quality characteristics can be executed separately for the blocks BLKₖ with move marks and for the blocks BLKₖ without move marks.

The following description is given on the basis of concrete examples with reference to FIGS. 8 through 13. FIGS. 8 through 10 illustrate a case where shooting was made in chase of a major subject; whereas FIGS. 11 through 13 illustrate a case where shooting was made zoomy on a major subject. In case where a major subject is moving, shooting is generally made in a way to keep the major subject at the center of the image, that is, to keep the location of the major subject unmoved. As a result, the major subject image data OD in the clipping frame image data KD and the major subject image data OD in the continuous frame image data RD occupy approximately the same location of area, as shown in FIGS. 8 and 9. Accordingly, it is blocks BLK′ with hatched lines that correspond to the blocks without move marks and that make up the area of the image data corresponding to the major subject image data OD.

In case where shooting is made zoomy on a major subject, the major subject does not move off the center of the image but increases its occupying area in the image. As a result, the major subject image data OD in the clipping frame image data KD and the major subject image data OD in the continuous frame image data RD have the same center location, as shown in FIGS. 11 and 12. Accordingly, it is blocks BLK′ with hatched lines that correspond to the blocks without move marks and that make up the area of the image data corresponding to the major subject image data OD.

Concretely speaking, the analysis of image quality characteristic values includes: scanning plural pieces of image data that constitute the clipping frame image data KD on a pixel-by-pixel basis; and generating a histogram for each of R, G, and B components and Y (luminance) component. The CPU 200 also calculates characteristic values (statistics) such as average value, minimum value, maximum value, medium value, and variance for each of the R, G, B components and the Y (luminance) component. In this way, the CPU 200 can acquire image characteristic values of the frame image data KD with emphasis on the major subject image data OD through the following procedures.

(1) vary the number of samplings between the blocks BLK with move marks and the blocks BLK′ without move marks.

For example, the sampling can be executed for every pixel with respect to the blocks BLK′ with no move mark and for every two pixels in both vertical and horizontal directions with respect to the blocks BLK with move marks. The resulted image quality characteristic values thus acquired fall under the influence of the image characteristic values of the major subject image data OD, for which the sampling has been executed more frequently. This allows for acquisition of image quality characteristic values of the frame image data KD with emphasis on the image quality characteristic values of the major subject image data OD.

(2) vary weights to be assigned to the histograms generated for the respective blocks BLK in the course of summing up the histograms to acquire a histogram for the entire clipping frame image data.

For example, the histograms for the blocks BLK′ without move marks can be made four times as frequent and added to the histograms generated for the blocks BLK with move marks. The resulted image characteristic value thus acquired fall under the influence of the histograms (image characteristic values) of the major subject image data OD, which have been assigned with more weights. This allows for acquisition of image quality characteristic values of the frame image data KD with emphasis on the image quality characteristic values of the major subject image data OD.

(3) assign weights to the acquired image quality characteristic values according to whether or not the target block BLK is attached with a move mark and thereby acquire image quality characteristic values of the entire clipping frame image data KD.

For example, when the block BLK′ with no move mark has an average luminance of Yw and the block BLK with a move mark has an average luminance of Yb, the clipping frame image data KD as a whole has an average luminance Yave of:
Yave=(4Yw+Yb)/5.
Therefore, the resulted image quality characteristic values thus acquired come under the influence of the image quality characteristic values of the weighted major subject image data OD. This enables acquisition of image quality characteristic values of the frame image data KD with emphasis on the image quality characteristic values of the major subject image data OD.

The CPU 200 determines correction values for image quality of the clipping frame image data KD on the basis of the analysis results (step S160). In other words, the CPU 200 calculates a correction value for each of the image quality parameters or the parameters regarding image quality by using each of the characteristic values calculated by analyzing the clipping frame image data KD with emphasis on the major subject image data OD.

Examples of the image quality parameters include parameters regarding image quality such as contrast, brightness (lightness), color balance, saturation, sharpness, and the like. The correction value for each of the image quality parameters may be determined so as to zeroize or reduce the absolute value of a difference between the acquired characteristic value (the value of each image quality parameter) and its corresponding reference image quality parameter value, which is predefined for the image quality parameter and acts as a reference value of the image quality. The level of reduction may be set in advance or may be defined to be stepwise depending on the magnitude of the absolute value of the difference between the two values, or may alternatively be assignable by the user. Further alternatively, the level of reduction may be defined by information included in the moving image data MD and may be determined on the basis of such information. It should be noted herein that the reference image quality parameter value is a value that was experimentally acquired for each image quality parameter for the purpose of attaining good-looking image quality.

The CPU 200 executes image quality adjustment processing for the clipping frame image data KD by using the determined correction values (step S170). For each of the image quality parameters such as shadow, highlight, brightness, contrast, color balance, and memory color correcton, the image quality adjustment is executed by using tone curves (S curves) or histograms, which relate input levels of the R, G, B component and the Y component of the clipping frame image data KD to their output levels, respectively. Specifically, each correction value acquired for the corresponding image quality parameters is applied to each input level point given for the parameter, so as to alter the tone curves regarding the R, G, B component and the Y component, respectively. Values of the points not applied with correction values may be interpolated by a spline curve. Finally, the altered tone curves for the respective R, G, B components and the Y component are used to execute input-to-output conversion for the respective Y and R, G, B components of the clipping frame image data KD. This allows for acquisition of clipping frame image data KD with adjusted image quality as image data GD (static image data) for output-use.

Alternatively, another technique of image adjustment processing using histograms may use shadow points and highlight points, which have been acquired by analyzing the clipping frame image data KD, together with the reference parameter values to determine level correction values, and then use the determined level correction values to execute level correction and extension of the histograms.

The CPU 200 outputs the clipping frame image data KD that has gone through the image quality adjustment processing to a printer driver or a display driver in a form of output image data (step S180), and ends the present processing routine. In the printer driver, processing such as RGB to CMYK color conversion processing using e.g. a look-up table, halftone processing, or the like is executed to output the output image data to the printer 30 in a form of raster data with print control command. This enables acquisition of output image for the clipping frame image data KD that was clipped out of the moving image data MD.

As discussed above, in the process of executing image quality processing for the frame image data KD that was clipped out of the moving image data MD, the personal computer 20 as an image processing apparatus of the first embodiment can execute image quality processing with emphasis on the image quality characteristics of the major subject image data OD. That is, in the process of determining correction values for the clipping frame image data KD, the personal computer 20 can give preference to the image quality characteristics of the major subject image data OD over the image quality characteristics of the data other than the major subject image data OD within the clipping frame image data KD. The correction values thus acquired are suited to the major subject image data OD that should play a central role in the output image. In this way, a good-looking image can be acquired for the major subject. Additionally, optimization of output image acquired for the major subject image data OD that plays a central role in the output image can result in acquisition of high quality, good-looking output image for the clipping frame image data KD.

In the process of specifying major subject image data OD, the personal computer 20 uses two continuous pieces of frame image data to specify major subject image data OD that should play a central role in the output image of the clipping frame image data KD. In this way, all that is required for the user is to select one piece of frame image data that contains the major subject and is desirable to be clipped out, in order to acquire the clipping frame image data KD that has gone through image quality adjustment processing best suited to major subject image data and thereby to have an output image of the clipping frame image data KD.

### Second Embodiment

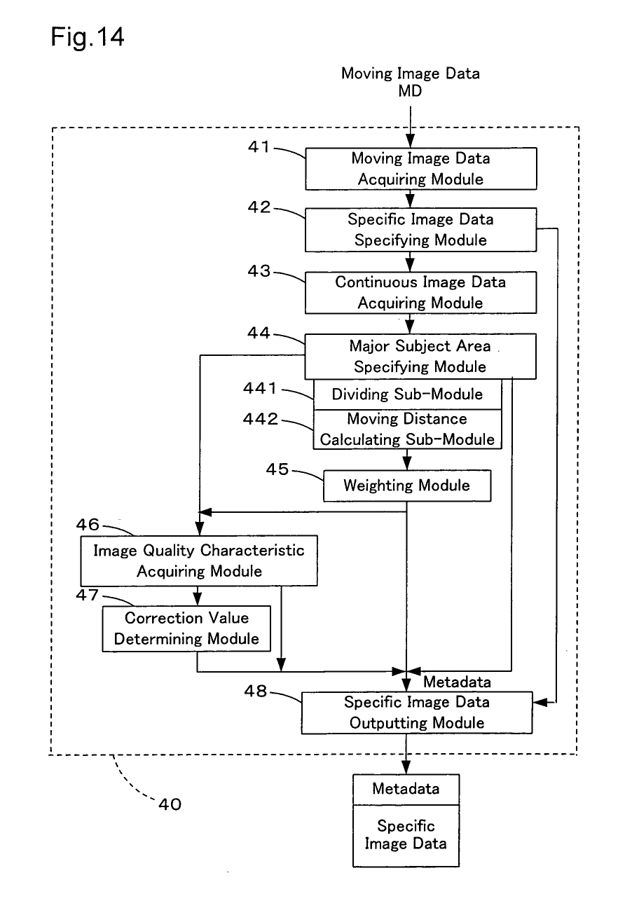

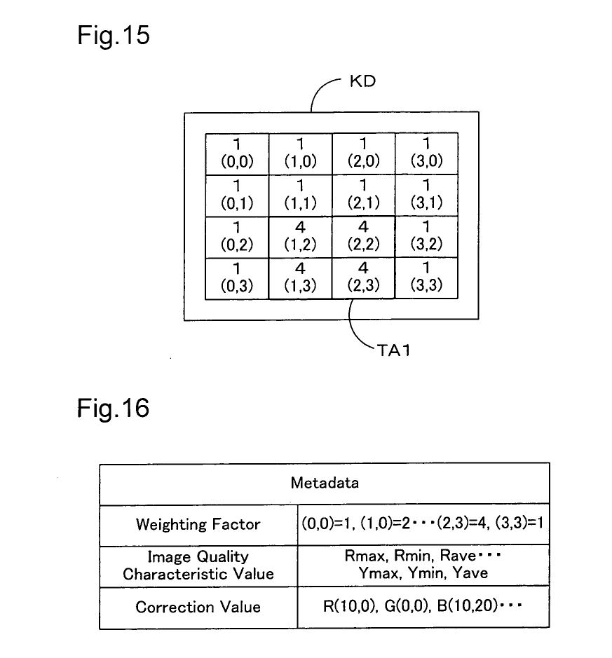

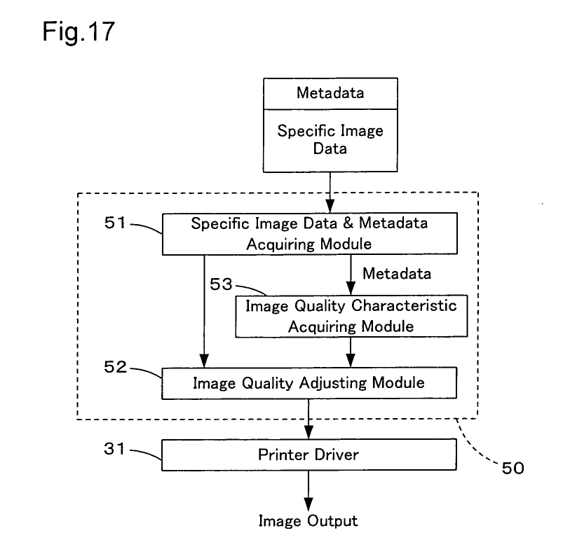

The following describes a second embodiment with reference to FIGS. 14 through 17. In the second embodiment, the image processing apparatus according to the first embodiment is realized as a combination of an image data generating apparatus and an image quality correcting apparatus. In other words, clip out of clipping frame image data KD (functions of application, for example) and adjustment of image quality for the clipping frame image data KD (functions of driver, for example) are executed separately. FIG. 14 is a functional block diagram showing the functional arrangement of an image data generating apparatus according to the second embodiment. FIG. 15 is an illustration showing one example of major subject area within clipping frame image data and weighting factors assigned to its respective blocks. FIG. 16 is an illustration showing one example of metadata that is associated with the clipping frame image data by means of the image data generating apparatus according to the second embodiment. FIG. 17 is a functional block diagram showing the functional arrangement of an image quality correcting apparatus according to the second embodiment.

An image data generating apparatus 40 comprises a CPU that executes various processing operations; and a memory that stores various execution modules and sub-modules, wherein the CPU executes the various execution modules and sub-modules to attain various functions of the image data generating apparatus 40. The image data generating apparatus 40 may be realized as a digital video camera, digital still camera, or a personal computer, for example. Alternatively, the functions of the image data generating apparatus 40 may be realized as application programs. The following describes operations of the image data generating apparatus 40 with use of the various execution modules and sub-modules.

A moving image data acquiring module 40 acquires moving image MD that is composed of plural pieces of image data that are continuous in time series. A specific image data specifying module 42 specifies one piece of image data within the acquired moving image data MD as specific image data (clipping frame image data KD). A continuous image data acquiring module 43 acquires plural pieces of image data that are continuous with the specified clipping frame image data (continuous frame image data RD).

A major subject area specifying module 44 uses the acquired clipping frame image data KD and continuous frame image data RD to specify a major subject area within the clipping frame image data KD. The major subject area specifying module 44 may further comprise: a dividing sub-module 441 that divides the clipping frame image data KD into a plurality of blocks; and a moving distance calculating module 442 that calculates a moving distance of each block in the continuous frame image data RD to classify the blocks into two categories, that is, a first group of blocks (blocks not attached with move marks) and a second group of blocks (blocks attached with move marks). The concrete procedures for specifying a major subject area, calculating moving distances of blocks, and classifying blocks are already described in the first embodiment and are not described again.

A weighting module 45 executes processing of weighting for the major subject area specified by the major subject area specifying module 44 or for the blocks not attached with move marks. The processing of weighting is described below with reference to FIG. 15. In an example shown in FIG. 5, an area TA1 enclosed by heavy lines corresponds to the major subject area (blocks not attached with move marks); whereas the remaining area corresponds to the area other than the major subject area (blocks attached with move marks).

It goes without saying that, alternatively, the major subject area or the blocks may directly be assigned with weighting factors without being attached with move marks. More specifically, each block with a moving distance of less than a criterion threshold value may be assigned with a weighting factor larger than that assigned to each block with a moving distance of no less than the criterion threshold value. Alternatively, every block may initially be assigned with a weighting factor of one as a default value and each block with a moving distance of less than the criterion threshold value may subsequently be assigned with a weighting factor larger than one.

In the example shown in FIG. 15, a weighting factor of four is assigned to each block that belongs to or contained in the major subject area TA1; whereas a weighting factor of one is assigned to each block that belongs to or contained in the area other than the major subject area TA1. The weighting factors may take any other combinations of values, as long as the weighting factor that is assigned to each block belonging to or contained in the major subject area TA1 is larger than the weighting factor that is assigned to each block belonging to or contained in the area other than the major subject area TA1. Alternatively, in case where the criterial weighting factor is one in the example shown in FIG. 15, it may be said that only the blocks that belong to or contained in the major subject area TA1 are assigned with weighting factors and the blocks that belong to or contained in the area other than the major subject area TA1 are not assigned with weighting factors. Further alternatively, more than one criterion threshold values may be used to determine moving distances of the blocks. This enables classification of the blocks into more than two categories, that is, into a major subject area, a major subject peripheral area, and a remaining area, for example. In this way, the gap of image quality can be reduced at the boundary of the major subject area and the remaining area, while the image quality adjustment can be executed with emphasis on the improvement of image quality of the major subject area.

An image quality characteristic acquiring module 46 uses information of the major subject area or the weighting factors to acquire image quality characteristic values with emphasis on image quality characteristic values of the major subject area. That is to say, the image quality characteristic acquiring module 46 acquires image quality characteristic values that reflect characteristics of image quality of the major subject area, such as color balance, saturation, sharpness, and brightness, as image quality characteristic values of the clipping frame image data KD.

A correction amount determining module 47 uses the image quality characteristic values acquired by the image quality characteristic acquiring module 46 to determine correction values (image quality correction values) that are to be applied to the clipping frame image data KD.

A specific image data outputting module 38 uses at least one of the weighting factors assigned by the weighting module 45, the image quality characteristic values acquired by the image quality characteristic acquiring module 46, and the correction values determined by the correction amount determining module 47 as metadata, and associates and outputs the metadata with the clipping frame image data KD.

The metadata, for example, has information shown in FIG. 16 stored therein. In the example of FIG. 16, the weighting factors are described in relation to positional information of the respective blocks; the image quality characteristic values are described as statistics of the respective R, G, B, and Y components, such as maximum value, minimum value, average value, deviation of color balance, saturation characteristic value, and sharpness; and the correction values are described as correction factors (for saturation and sharpness), and increases and decreases of tone curve passing points at correction points (points of ¼ and ¾ of input value, for example) of the tone curves for the respective R, G, B, and Y (for contrast, brightness, and color balance).

When outputting the weighting factors as metadata, the image data generating apparatus 40 executes the processing up to step S130 described with reference to FIG. 3 and the processing of steps S200 though S250 described with reference to FIG. 4. When outputting the image quality characteristic values as metadata, the image data generating apparatus 40 executes the processing up to step S140 described with reference to FIG. 3 and the processing of steps S200 through S250 described with reference to FIG. 4. When outputting the correction values as metadata, the image data generating apparatus 40 executes the processing up to step S150 described with reference to FIG. 3 and the processing of steps S200 through S250 described with reference to FIG. 4.

The following describes an image quality correcting apparatus 50 with reference to FIG. 17. The image quality correcting apparatus 50 comprises a CPU that executes various processing operations; and a memory that stores various execution modules and sub-modules, wherein the CPU executes the various execution modules and sub-modules to attain various functions of the image quality correcting apparatus 50. The image quality correcting apparatus 50 may be realized as a personal computer, a printer, or a display apparatus, for example. Alternatively, the functions of the image quality correcting apparatus 50 may be realized as a printer driver or a display driver. The following describes operations of the image quality correcting apparatus 50 with use of the various execution modules and sub-modules.

Specific image data (clipping frame image data KD) that is associated with metadata is loaded into the image quality correcting apparatus 50 by means of a specific image data & metadata acquiring module 51. In case where the metadata comprises image quality characteristic values or image quality correction values, the clipping frame image data KD and the image quality correction values are transmitted to an image quality adjusting module 52.

In case where image quality characteristic values are described as the metadata, the image quality adjusting module 52 executes the processing of and after the step S150 described with reference to FIG. 3. In case where image quality correction values are described as the metadata, the image quality adjusting module 52 executes the processing of and after the step S160 described with reference to FIG. 3.

In case where the metadata comprises weighting factors, the metadata is transmitted to an image quality characteristic acquiring module 53 and the clipping frame image data DK is transmitted to an image quality adjusting module 52. The image quality characteristic acquiring module 53 uses the weighting factors described as the metadata to acquire image quality characteristic values. More specifically, the image quality characteristic acquiring module 53 executes the processing of step S140 described with reference to FIG. 3 and the image quality adjusting module 52 executes the processing of and after the step S150 described with reference to FIG. 3. The following three types of methods are possible as examples of the method for acquiring image quality characteristic values that uses weighting factors.

(1) In clipping frame image data KD, the number of samplings of image analysis for an area or blocks with weighting factors no less than a given value is made larger than the number of samplings of image analysis for an area or blocks with weighting factors less than the given value. For example, every one pixel can be sampled for an area or blocks with weighting factors no less than a given value; whereas every two pixels can be sampled both in vertical and horizontal directions for an area or blocks with weighting factors less than the given value. The resulted image quality characteristic values thus acquired fall under the influence of image quality characteristic values of image data that corresponds to the major subject area, for which the sampling had been executed more frequently. This enables acquisition of image quality characteristic values of the frame image data KD with emphasis on image quality characteristic values of image data that corresponds to the major subject area.

(2) Weighting factors are used to vary weights to be assigned in the course of summing up histograms respectively generated for a major subject area and an area other than the major subject area or histograms generated for respective blocks so as to generate a histogram for the entire clipping frame image data. For example, histograms for the blocks with weighting factors no less than a given value can be made four times as frequent and added to histograms for the blocks with weighting factors less than the given value. The resulted image quality characteristic values thus acquired fall under the influence of histograms (image characteristic values) of image data that corresponds to the weighted major subject area. This enables acquisition of image characteristic values of the clipping frame image data KD with emphasis on image quality characteristic values of image data that corresponds to the major subject area.

(3) Image quality characteristic values are respectively calculated for a major subject area and an area other than the major subject area or for respective blocks, and weighting factors are then used to assign weights to the acquired image quality characteristic values, so as to give image characteristic values for the entire clipping frame image data KD. For example, when blocks with weighting factors of no less than a given value have an average luminance of Yw and blocks with weighting factors of less than the given value have an average luminance of Yb, the entire clipping frame image data KD has an average luminance Yave of:
Yave=(4Yw+Yb)/5.
Therefore, the resulted image quality characteristic values thus acquired come under the influence of the image quality characteristic values of the image data that corresponds to the weighted major subject area. This enables acquisition of image quality characteristic values of the frame image data KD with emphasis on the image quality characteristic values of the image data that corresponds to the major subject area.

The image quality adjusting module 52 transmits the clipping frame image data that has gone through the image quality adjustment as output image data to a printer driver 31, which in turn uses the output image data to output an image.

As described above, in accordance with the image data generating apparatus 40 according to the second embodiment, metadata that contains information regarding a major subject area or information generated by using the information regarding a major subject area can be associated and output with clipping frame image data KD. This in turn enables execution of image processing for the clipping frame image data KD, with emphasis on the improvement of image quality of a major subject and with use of the clipping frame image data KD and the metadata.

Additionally, in accordance with the image quality correction apparatus 50 according to the second embodiment, the received clipping frame image data KD and the metadata can be used to execute image processing for the clipping frame image data KD with emphasis on the improvement of image quality of a major subject. In other words, information regarding a major subject area or metadata containing the information regarding a major subject area can be used at the execution of automatic image quality adjustment (image quality adjustment that uses reference values) for the clipping frame image data KD.

Furthermore, since the metadata is associated with the clipping frame image data KD, the clipping frame image data KD can be searched by the metadata. For example, in case where positional information or weighting factors of a major subject area are described as the metadata, it is possible to search for image data of an image that has the major subject located at its central lower part. Alternatively, in case where image quality characteristic values are described as the metadata, it is possible to search for image data of an image that is bright, dark, or has a good contrast when compared to the criterial indices.

### Other Embodiments

In the embodiments discussed above, the analysis of clipping frame image data KD with emphasis on major subject image data OD is executed for both the major subject image data OD and the clipping frame image data KD other than the major subject image data OD. The analysis that is purposed for acquiring image quality characteristic values (sampling), however, may alternatively be executed only for pixel data that constitute the major subject image data OD. In such a case, the clipping frame image data KD goes through image quality adjustment processing that only reflects image quality characteristics of the major subject image data OD. This enables execution of image quality adjustment processing more suited for the major subject image.

In the embodiments discussed above, the process of using clipping frame image data KD and continuous frame image data RD to specify major subject image data OD uses all coordinate points (x, y) included in the blocks BLK of the frame (I). The process, however, may alternatively divide each block BLKₖ into 8 to 16 portions in both vertical and horizontal directions and calculate the previously-described moving distance BVₖ on the basis of the acquired 64 to 256 lattice points. This enables quicker calculation of the moving distance of the block BLKₖ.

The above discussion of the embodiments provides no detailed description with respect to a case where no major subject image data OD can be specified, that is, less or no area of small movement (area of minimal change) exists within the clipping frame image data KD. In such a case, the central area of the clipping frame image data KD may be regarded as the major subject image data OD or alternatively, the clipping frame image data KD may not go through the analysis with emphasis on the major subject image data OD. It may be difficult to properly specify the major subject image data KD under such circumstances. However, since the major subject image data OD is often located at the central area of the clipping frame image data KD, it is highly possible that the image quality adjustment processing can be executed suitably for the major subject image data OD. On the other hand, in case where substantially no minimal change area exists, it may be difficult to execute the image quality adjustment processing with emphasis on the image quality characteristics of the major subject image data OD. In such a case, the analysis with emphasis on the major subject image data OD may be eliminated.

It goes without saying that the method of calculating movement vectors of blocks BLK, which is described above along with the embodiments, is merely an example and that a variety of other known methods are also available for calculating moving distances BV of the blocks BLK. For example, a coordinate point with a pixel value that is closest to a pixel value P0 (x, y) of a coordinate point (x, y) within a block BLK of the frame (I) may be searched from the entire pixel data of the frame (I+1). In other words, all that is required is to specify major subject image data OD by using two continuous pieces of image information.

Although the digital video camera 11 is employed as the image data generating apparatus in the embodiments discussed above, a digital still camera may alternatively be used as well. In other words, although moving image data is employed as plural pieces of image data that are continuous in time series in the embodiments discussed above, other data may alternatively be employed as well, such as plural pieces of continuous static image data that are continuous in time series (consecutive image data) and are shot in a so-called continuous shooting mode by means of a digital still camera, for example. In such a case, the plural pieces of image data that are shot in the continuous shooting mode may be grouped and treated altogether as one file so as to allow the use of the consecutive image data in place of the moving image data. Since the consecutive image data is also continuous in time series, even in case where the consecutive image data is used, its major subject can be clipped out both readily and properly by the above-described method. It should be noted herein that the consecutive image data is preferably continuous at time intervals of less than a given time period.

Although the personal computer 20 is employed as an image processing apparatus to execute image processing in the embodiments discussed above, other apparatuses such as a stand-alone type printer with image processing functions and a display apparatus may alternatively be employed as well. In such a case, the image processing is executed by the printer or by the display apparatus. Alternatively, the image processing may be implemented as a printer driver or an image processing application (program) with no accompanying hardware configuration such as the image processing apparatus. Examples of the display apparatus include CRT, liquid crystal display, projector, and the like.

Furthermore, all or part of the image processing that are executed by the personal computer 20 may alternatively be executed by the digital video camera 100. This is achieved by endowing moving image editing application that is stored in e.g. a ROM of the digital video camera 11 with the image processing functions that are described above in the embodiments. The digital video camera 11 generates data for print-use that contains print control command and static image data for print-use and provides the data to the printer 30 via a cable or via a memory card. The printer 30 forms dot patterns on a print medium according to the received print-use data and then outputs an image. Alternatively, the digital video camera 11 may provide clipping frame image data KD (static image data) that has gone through image quality adjustment processing to the personal computer 20 or to the printer 30. In such a case, the personal computer 20 or the printer 30 generates the data for print-use that contains print control command.

Although the image processing is executed as image processing software or computer program in the embodiments discussed above, the image processing may alternatively be executed by using a static image data processing hardware circuit that is equipped with a logic circuit for executing each processing (step) described above. This enables reduction of the load on the CPU 200 as well as execution of quicker image processing. The image processing hardware circuit may be implemented as a mounted circuit for the digital video camera 11 and the printer 30 and may also be implemented as an add-on card for the personal computer 20.

In case where plural pieces of clipping frame image data are clipped out of a single scene (shot scene), execution of the image quality adjustment processing independently for each piece of clipping frame image data by using its image characteristic values may cause the trend of image quality adjustment to vary widely among the plural pieces of clipping frame image data. For example, in case where plural pieces of clipping frame image data are clipped out of a scene of a vehicle coming up from afar, the plural pieces of clipping frame image data may range from the one with a small major subject to the one with a large major subject. For the clipping frame image data with a small major subject, its image characteristic values may strongly be influenced by the background; whereas for the clipping frame image data with a large major subject, its image characteristic values may strongly be influenced by the major subject. For this reason, execution of the image quality adjustment processing both separately and most suitably for each piece of clipping frame image data may cause difficulty in maintaining harmony as a whole.

In order to resolve such a problem, average values may be taken from image quality characteristics or image quality correction values of the respective pieces of clipping frame image data and the average values thus acquired may be used in the image quality adjustment processing for each piece of clipping frame image data. This enables unification of the trend of image quality adjustment (harmonization of processing results) among the plural pieces of clipping frame image data that were clipped out of a single scene.

Alternatively, image quality characteristics or image quality correction values of clipping frame image data with a largest major subject area may be used in the image quality adjustment processing for each piece of clipping frame image data. The present embodiment is aimed at the improvement of image quality of the major subject, and can optimize the image quality adjustment for the clipping frame image data with a largest major subject area and at the same time, also can maintain harmony in the trend of image quality adjustment for the each piece of clipping frame image.

Although the image processing apparatus, the image data generating apparatus, the image quality correcting apparatus, and the methods and the programs for the same according to the present invention have been described above in terms of embodiments, the modes for embodying the present invention are only purposed to facilitate understanding of the present invention and are not considered to limit the present invention. There may be various changes, modifications, and equivalents without departing from the scope and spirit of the claims of the present invention.

The following Japanese Patent applications, on the basis of which the present application claims priority, are incorporated herein by reference.
(1) Patent Application No. 2003-375259 (Date of Application: Nov. 5, 2003)
(2) Patent Application No. 2004-199953 (Date of Application: Jul. 7, 2004)

1. A method of image processing that executes image processing for image data acquired from plural pieces of image data, the plural pieces of image data being continuous in time series, the method comprising:
acquiring continuous image data from among the plural pieces of image data that are continuous in time series, the continuous image data being image data that is continuous with one piece of specific image data, the specific image data being specified from among the plural pieces of image data that are continuous in time series;
specifying major subject image data within the specific image data by using the specific image data and the continuous image data;
acquiring image quality characteristics of the specific image data with emphasis on the specified major subject image data by analyzing the specific image data; and
executing image quality adjustment for the specific image data by using the acquired image quality characteristics.

2. A method of image processing in accordance with claim 1, wherein the acquiring image quality characteristics of the specific image data with emphasis on the specified major subject image data by analyzing the specific image data is executed by raising frequency of analysis for the specified major subject image data higher than that for the specific image data other than the specified major subject image data.

3. A method of image processing in accordance with claim 1, wherein the acquiring image quality characteristics of the specific image data with emphasis on the specified major subject image data by analyzing the specific image data is executed by assigning a larger weight to the image quality characteristics acquired from the specified major subject image data than to the image quality characteristics acquired from the specific image data other than the specified major subject image data.

4. A method of image processing in accordance with claim 2, wherein the specifying major subject image data is executed by specifying a minimal change area within the specific image data by using the specific image data and the continuous image data.

5. A method of image processing in accordance with claim 4, wherein the image data is composed of plural pieces of pixel data, and
wherein the specifying a minimal change area is executed by, from among the plural pieces of pixel data that constitute the specific image data, specifying an area in which variation between each constituent pixel data and its corresponding pixel data in the continuous image data is no more than a given value as the minimal change area.

6. A method of image processing in accordance with claim 2, wherein the specifying major subject image data is executed by:
dividing the specific image data into a plurality of blocks;
calculating a moving distance of each divided block in the continuous image data; and
specifying major subject image data with emphasis on the blocks having moving distances of less than the given value among the plurality of blocks.

7. A method of image processing in accordance with claim 1, wherein the executing image quality adjustment for the specific image data is executed by increasing or decreasing preset correction values by using the acquired image quality characteristics.

8. A method of image processing in accordance with claim 1, wherein the image quality characteristics are statistics of one or more image quality parameters that indicate characteristics regarding image quality of the specific image data, and
wherein the executing image quality adjustment for the specific image data is executed by correcting the statistics so as to eliminate or reduce deviations between the acquired statistics of the one or more image quality parameters and reference parameter values preset for the one or more image quality parameters and then by using the corrected statistics.

9. A method of image processing in accordance with claim 1, wherein the image quality characteristics are statistics of one or more image quality parameters that indicate characteristics regarding image quality of the specific image data, and
wherein the executing image quality adjustment for the specific image data is executed by determining correction values so as to eliminate or reduce deviations between the acquired statistics of the one or more image quality parameters and reference parameter values preset for the one or more image quality parameters and then by applying the determined correction values to the specific image data.

10. A method of image processing that executes image processing for image data acquired from plural pieces of image data, the plural pieces of image data being continuous in time series, the method comprising:
acquiring a continuous scene from among the plural pieces of image data that are continuous in time series, the continuous scene being another scene that is within a given time period from one specific scene, the specific scene being specified from among the plural pieces of image data that are continuous in time series;
specifying a major subject area within the specific scene by using image data of the specific scene and image data of the continuous scene;
acquiring image quality characteristics of the image data of the specific scene with emphasis on the specified major subject area by analyzing the image data of the specific scene; and
executing image quality adjustment for the image data of the specific scene by using the acquired image quality characteristics.

11. A method of image processing in accordance with claim 1, wherein the plural pieces of image data that are continuous in time series comprise moving image data.

12. An image processing apparatus that executes image processing for image data acquired from plural pieces of image data, the plural pieces of image data being continuous in time series, the apparatus comprising:
a continuous image data acquiring module that, from among the plural pieces of image data that are continuous in time series, acquires image data that is continuous with one piece of specific image data as continuous image data, the specific image data being specified from among the plural pieces of image data that are continuous in time series;
a major subject image data specifying module that specifies major subject image data within the specific image data by using the specific image data and the continuous image data;
an image quality characteristic acquiring module that acquires image quality characteristics of the specific image data with emphasis on the specified major subject image data by analyzing the specific image data; and
an image quality adjusting module that executes image quality adjustment for the specific image data by using the acquired image quality characteristics.

13. An image processing apparatus in accordance with claim 12, wherein the plural pieces of image data that are continuous in time series comprise moving image data.

14. A method of generating image data that associates and outputs metadata with one piece of image data selected from among plural pieces of image data, the plural pieces of image data being continuous in time series, the method comprising:
acquiring continuous image data from among the plural pieces of image data that are continuous in time series, the continuous image data being image data that is continuous with one piece of specific image data, the specific image data being specified from among the plural pieces of image data that are continuous in time series;
specifying a major subject area within the specific image data by using the specific image data and the continuous image data, the major subject area representing a major subject; and
associating and outputting metadata with the specified specific image data, the metadata containing information regarding the specified major subject area or information generated by using the information regarding the specified major subject area.

15. A method of generating image data in accordance with claim 14, wherein each image data is composed of plural pieces of pixel data,
wherein the specifying a major subject area is executed by, from among the plural pieces of pixel data that constitute the specific image data, specifying an area in which variation between each constituent pixel data and its corresponding pixel data in the continuous image data is no more than a given value as the major subject area, and
wherein the metadata contains positional information regarding the major subject area specified within the specific image data.

16. A method of generating image data in accordance with claim 15, further comprising:
acquiring characteristic values of image quality of the specific image data by analyzing the specific image data such that the frequency of analysis for the specified major subject area becomes higher than that for the area other than the specified major subject area, and
wherein the metadata contains the acquired image quality characteristic values.

17. A method of generating image data in accordance with claim 15, further comprising:
acquiring image characteristic values that indicate characteristics of image quality of the specific image data respectively in relation to the specified major subject area and the area other than the specified major subject area by analyzing the specific image data, and acquiring image quality characteristic values of the specific image data by assigning weights to the image quality characteristic values acquired in relation to the specific major subject area, and
wherein the metadata contains the acquired image quality characteristic values.

18. A method of generating image data in accordance with claim 16, further comprising:
determining correction values for adjusting image quality of the specific image data by using the acquired image quality characteristic values, and
wherein the metadata contains the determined correction values.

19. A method of generating image data in accordance with claim 14, wherein the specifying a major subject area is executed by:
dividing the specific image data into a plurality of blocks;
calculating a moving distance of each divided block in the continuous image data; and
among the plurality of blocks, specifying one or more first blocks with the moving distance of less than a given value as the major subject area, and wherein the method of generating image data further comprises:
assigning a larger weighting factor to the first block than to a second block with the moving distance of no less than the given value, and
wherein the metadata contains weighting factors respectively assigned to the first block and the second block.

20. A method of generating image data in accordance with claim 19, further comprising:
acquiring characteristic values of image quality of the specific image data with emphasis on the specified major subject area by analyzing the specific image data such that the frequency of analysis for the first block becomes higher than that for the second block, and
wherein the metadata contains the acquired image quality characteristic values.

21. A method of generating image data in accordance with claim 19, further comprising:
acquiring image characteristic values that indicate characteristics of image quality of the specific image data respectively in relation to the first group of blocks and the second group of blocks by analyzing the specific image data, and acquiring image quality characteristic values of the specific image data by assigning weights to the image quality characteristic values acquired in relation to the first group of blocks, and
wherein the metadata contains the acquired image quality characteristic values.

22. A method of generating image data in accordance with claim 20, further comprising:
determining correction values for adjusting image quality of the specific image data by using the acquired image quality characteristic values,
wherein the metadata contains the determined correction values.

23. A method of correcting image quality that executes image quality adjustment processing for image data by using metadata associated with the image data, comprising:
acquiring one piece of specific image data and metadata associated with the specific image data, the specific image data being specified from among plural pieces of image data that are continuous in time series, the metadata containing information regarding a major subject area specified within the specific image data or information generated by using the information regarding the specified major subject area; and
executing image quality adjustment processing for the acquired specific image data by using the acquired metadata.

24. A method of correcting image quality in accordance with claim 23, further comprising:
acquiring image quality characteristic values that indicate image quality of the acquired specific image data by analyzing the specific image data,
wherein in case where the acquired metadata comprises weighting factors or positional information of the major subject area, the acquiring image quality characteristic values is executed with emphasis on the specific image data of the major subject area by using the weighting factors or the positional information of the major subject area, and
wherein the executing image quality adjustment for the specific image data is carried out by determining correction values so as to eliminate or reduce deviations between statistics of the acquired one or more image quality parameters and reference parameter values preset for the one or more image quality parameters and then by applying the determined correction values to the specific image data.

25. A method of correcting image quality in accordance with claim 23, wherein in case where the acquired metadata comprises image quality characteristic values as well as statistics of one or more image quality characteristic parameters indicating characteristics regarding image quality of the specific image data, the executing image quality adjustment for the specific image data is carried out by determining correction values so as to eliminate or reduce deviations between the acquired statistics of the one or more image quality parameters and reference parameter values preset for the one or more image quality parameters and then by applying the determined correction values to the specific image data.

26. A method of correcting image quality in accordance with claim 23, wherein in case where the acquired metadata comprises correction values, the executing image quality adjustment for the specific image data is carried out by applying the acquired correction values to the specific image data.
